(19) United States
(12) Patent Application Publication
(10) Pub. No.: US 2019/0384954 A1
(43) Pub. Date: Dec. 19, 2019

(54) DETECTING BARCODES ON IMAGES

(71) Applicant: ABBYY Production LLC, Moscow (RU)

(72) Inventors: Yakov Lyubimov, Moscow Region (RU); Konstantin Gudkov, Khanty-Mansiyskiy AO - Yugra AO (RU)

(21) Appl. No.: 16/016,544

(22) Filed: Jun. 22, 2018

(30) Foreign Application Priority Data
Jun. 18, 2018 (RU) 2018122093

(51) Int. Cl. G06K 7/14; G06T 5/00; G06T 7/187; G06T 5/20; G06K 9/00; G06K 9/62; G06K 19/06; G06N 99/00; G06K 7/10

(52) U.S. Cl. CPC G06K 7/1413; G06T 5/008; G06T 7/187; G06T 5/20; G06T 5/40; G06K 9/6202; G06K 19/06028; G06N 99/005; G06K 7/10722; G06K 9/00577

(57) ABSTRACT

Systems and methods to receive an image for detecting barcodes on the image; place a plurality of image patches over the image, each of the plurality of image patches corresponding to a region of pixels; identify, from the plurality of image patches, a subset of image patches overlapping with one or more barcodes associated with the image; merge two or more image patches of the subset of image patches together to form one or more combined image patches; and generate one or more individual connected components using the one or more combined image patches, the one or more individual connected components to be identified as one or more detected barcodes.

### REFERENCE TO RELATED APPLICATIONS

The present application claims the benefit of priority under 35 U.S.C. § 119 to Russian Patent Application No. 2018122093 filed Jun. 18, 2018, the disclosure of which is incorporated herein by reference in its entirety for all purposes.

### TECHNICAL FIELD

The present disclosure is generally related to image processing, and is more specifically related to systems and methods for detecting objects located on images, including, detecting presence of barcodes on images.

### BACKGROUND

Codes, such as barcodes, are used in a variety of applications in the modern era. A barcode is an optical machine readable representation of data. Many barcodes represent data by varying width and spacing of lines, rectangles, dots, hexagons, and other geometric patterns. Examples of codes (generally referred in the present disclosure as “barcodes”) can include two-dimensional matrix barcodes, Aztec Code, Color Construct Code, CrontoSign, CyberCode, d-touch, DataGlyphs, Data Matrix, Datastrip Code, Digimarc Barcode, DotCode, Dot Code A, digital paper, DWCode, EZcode, High Capacity Color Barcode, Han Xin Barcode HueCode, InterCode, MaxiCode, MMCC, NexCode, Nintendo e-Reader#Dot code, PDF417, Qode, QR code, AR Code, ShotCode, Snapcode, also called Boo-R code, SPARQCode, VOICEYE, etc. Barcodes can be contained on or within various objects, including, on printed documents, digital images, etc. In order to recognize the data represented by a barcode on an image, it is necessary to first detect the presence of a barcode on the image.

### SUMMARY OF THE DISCLOSURE

In accordance with one or more aspects of the present disclosure, an example method for detecting barcodes on images may comprise: receiving, by a processing device, an image for detecting barcodes on the image; placing a plurality of image patches over the image, each of the plurality of image patches corresponding to a region of pixels; identifying, from the plurality of image patches, a subset of image patches overlapping with one or more barcodes associated with the image; merging two or more image patches of the subset of image patches together to form one or more combined image patches; and generating one or more individual connected components using the one or more combined image patches, the one or more individual connected components to be identified as one or more detected barcodes.

In accordance with one or more aspects of the present disclosure, an example system for detecting barcodes on images may comprise: a memory; and a processor, coupled to the memory, the processor to: receive an image for detecting barcodes on the image; place a plurality of image patches over the image, each of the plurality of image patches corresponding to a region of pixels; identify, from the plurality of image patches, a subset of image patches overlapping with one or more barcodes associated with the image; merge two or more image patches of the subset of image patches together to form one or more combined image patches; and generate one or more individual connected components using the one or more combined image patches, the one or more individual connected components to be identified as one or more detected barcodes.

In accordance with one or more aspects of the present disclosure, an example computer-readable non-transitory storage medium may comprise executable instructions that, when executed by a processing device, cause the processing device to: receive an image for detecting barcodes on the image; place a plurality of image patches over the image, each of the plurality of image patches corresponding to a region of pixels; identify, from the plurality of image patches, a subset of image patches overlapping with one or more barcodes associated with the image; merge two or more image patches of the subset of image patches together to form one or more combined image patches; and generate one or more individual connected components using the one or more combined image patches, the one or more individual connected components to be identified as one or more detected barcodes.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level component diagram of an example system architecture, in accordance with one or more aspects of the present disclosure.

FIG. 2 depicts a flow diagram of one illustrative example of a method for detecting barcodes on an image, in accordance with one or more aspects of the present disclosure.

FIG. 3 depicts a machine learning scheme used for classification of superimposed images, in accordance with one or more aspects of the present disclosure.

FIG. 4 illustrates classified image patches for detection of barcodes, in accordance with one or more aspects of the present disclosure.

FIG. 5 depicts classified image patches for detection of barcodes, in accordance with one or more aspects of the present disclosure.

FIGS. 6A-6B illustrate combined image patches, in accordance with one or more aspects of the present disclosure.

FIGS. 7A-7B illustrate refining boundaries of combined image patches, in accordance with one or more aspects of the present disclosure.

FIGS. 8A-8B illustrate binarized images using morphology, in accordance with one or more aspects of the present disclosure.

FIGS. 9A-9B illustrate individual connected components, in accordance with one or more aspects of the present disclosure.

FIG. 10 illustrates examples of types of barcodes that can be detected, in accordance with one or more aspects of the present disclosure.

FIG. 11 depicts a component diagram of an example computer system which may execute instructions causing the computer system to perform any one or more of the methods discussed herein.

### DETAILED DESCRIPTION

Described herein are methods and systems for detecting barcodes on images.

“Computer system” herein shall refer to a data processing device having a general purpose processor, a memory, and at least one communication interface. Examples of computer systems that may employ the methods described herein include, without limitation, desktop computers, notebook computers, tablet computers, and smart phones.

Conventionally, different techniques have been used to detect barcodes on images. The techniques may include bar tracing, morphology algorithms, wavelet transformation, Hough transformation, simple connected component analysis, etc. These techniques do not always provide for sufficient effectiveness, speed, quality, and precision of detection of barcodes. For example, connected component analysis may be generally used to analyze areas of images that are small. Detecting barcodes on an image with a large area can become challenging or in some cases impossible. Detecting barcodes may pose challenges when there are multiple barcodes present on a single image. The complete areas of the barcode may not be detected with the precision that is necessary for accurate recognition of the barcodes. When barcodes are located close to each other, the quality and/or precision of detected barcodes may be compromised.

Aspects of the disclosure address the above noted and other deficiencies by providing mechanisms for detection of barcodes on images using image patches. The mechanism can automatically detect whether one or more barcodes are present within an image and identify the areas of the image containing the individual barcodes. The mechanism may include receiving an image on which barcode detection is to be performed. A plurality of image patches may be placed, or superimposed, over the image. As used herein, an “image patch” may refer to a region of pixels on an image. An image patch may include a container containing a portion of an image. Generally, but not always, the portion of the image may be a rectangular or a square portion. The image patches may cover the entirety of the received image. The image patches may be classified to identify potential image patches overlapping with barcodes on the received image. A preliminary classification may be performed to identify image patches that definitely do not contain at least a part of a barcode. The remainder of image patches (e.g., the patches with likelihood of containing some parts of barcodes) may be classified using a machine learning model to produce a second stage of classification of patches overlapping with barcodes.

Machine learning models are used to perform image patch classification, including pattern classification, and to perform image recognition, including optical character recognition (OCR), pattern recognition, photo recognition, facial recognition, etc. A machine learning model may be provided with sample images as training sets of images which the machine learning model can learn from. For example, training images containing barcodes may be used to train a machine learning model to recognize images containing barcodes. The trained machine learning model may be provided with the image patches and identify image patches that overlap with barcodes.

Image patches classified as containing barcodes are considered for merging. For example, two or more image patches may be merged together to form a combined image patch using a neighbor principle. Multiple combined image patches may be produced as a result of merging different sets of image patches. The combined image patches may be refined to identify boundaries of the combined image patches. The combined image patches with refined boundaries may be used to identify the barcodes inside the combined image patches. An individual connected component may be generated using a combined image patch. A crop may be performed along the boundaries of the individual connected component. Optionally, other classifications (e.g., using machine learning algorithms, gradient boosting algorithms, etc.) can be performed to determine whether the area of the connected component corresponds to a barcode. Following this mechanism, one or more individual connected components may be obtained, which may be identified as one or more detected barcodes on the received image.

As described herein, the technology provides for automatic detection of barcodes on a large variety of images. The technology provides means for identifying barcodes on an image that has other elements in addition to barcodes. The technology can separate barcodes from other objects on an image and identify areas of the image containing a barcode with precision and accuracy. The technology allows for identifying barcodes in images without restrictions on size of image or number of barcodes within the image. It can identify and distinguish between distinct barcodes even when the barcodes are located within close proximity of each other within an image. The systems and methods described herein allows for inclusion of a vast number of different types of images for detection of barcodes, improving the quality, accuracy, efficiency, effectiveness, and usefulness of barcode detection technology. The image processing effectively improves image recognition quality as it relates to barcode detection within the image. The image recognition quality produced by the systems and methods of the present disclosure allows significant improvement in the optical character recognition (OCR) accuracy over various common methods.

Various aspects of the above referenced methods and systems are described in details herein below by way of examples, rather than by way of limitation.

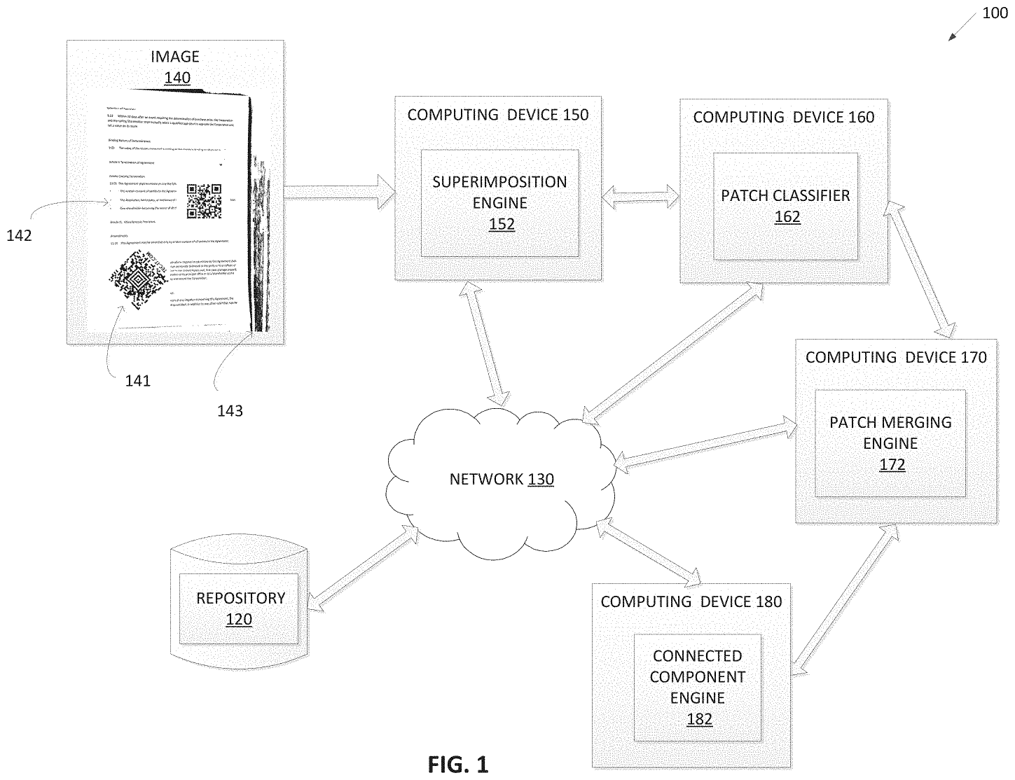

FIG. 1 depicts a high-level component diagram of an illustrative system architecture 100, in accordance with one or more aspects of the present disclosure. System architecture 100 includes computing devices 150, 160, 170, 180, and a repository 120 connected to a network 130. Network 130 may be a public network (e.g., the Internet), a private network (e.g., a local area network (LAN) or wide area network (WAN)), or a combination thereof.

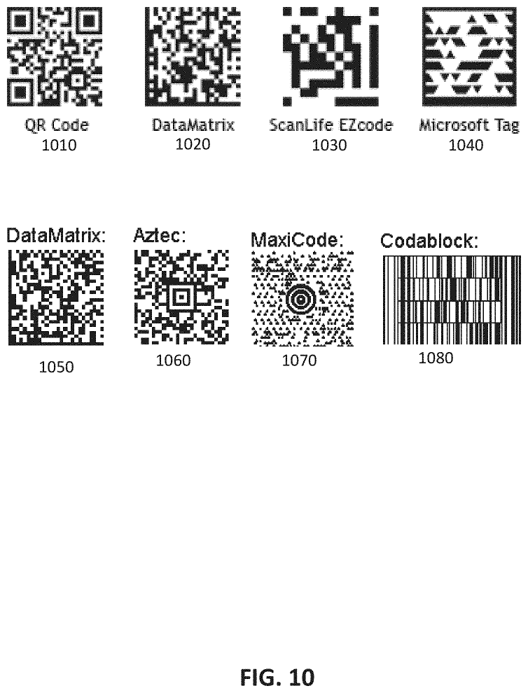

An image 140 may be used as an input image that is to be analyzed for presence of one or more barcodes. In one example, image 140 may be a digital image depicting a document. The document may be a printed document, an electronic document, etc. Image 140 may include objects 141, 142, and 143 representing, for example, a barcode, texts, lines etc. In one example, object 141 may be a barcode. In some embodiments, the barcodes can include one or more barcodes depicted in FIG. 10. In some examples, image 140 may not include any barcodes.

The image 140 may be received in any suitable manner. For example, a digital copy of the image 140 may be received by scanning a document or photographing a document. Additionally, in some instances a client device connected to a server via the network 130 may upload a digital copy of the image 140 to the server. In some instances, for a client device connected to a server via the network 130, the client device may download the image 140 from the server. The image 140 may depict a document or one or more of its parts. In an example, image 140 may depict a document in its entirety. In another example, image 140 may depict a portion a document. In yet another example, image 140 may depict multiple portions of a document. Image 140 may include multiple images.

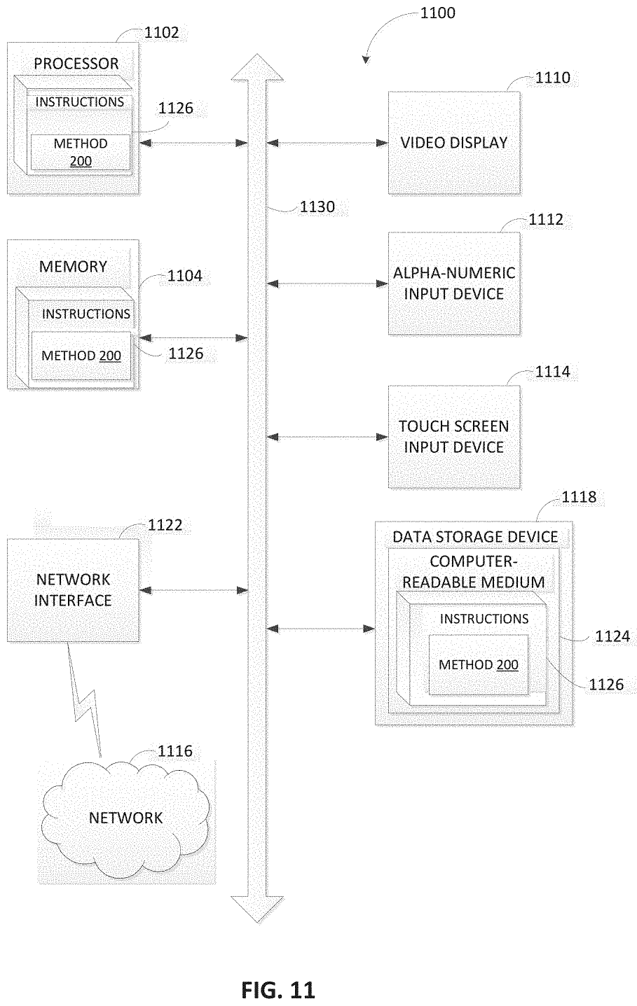

The various computing devices may host components and modules to perform functionalities of the system 100. Each of the computing devices 150, 160, 170, 180 may be a desktop computer, a laptop computer, a smartphone, a tablet computer, a server, a rackmount server, a router computer, a scanner, a portable digital assistant, a mobile phone, a camera, a video camera, a netbook, a desktop computer, a media center, or any combination of the above. In some embodiments, the computing devices can be and/or include one or more computing devices 1100 of FIG. 11.

System 100 may include a superimposition engine 152, a patch classifier 162, a patch merging engine 172, and a connected component engine 182. In one example, computing device 150 may include the superimposition engine 152 that is capable of superimposing (e.g., placing over) image patches over the received image 140. As used herein, an “image patch” may refer to a region of pixels on an image. An image patch may include a container containing a portion of an image. The image patches may cover the entirety of the received image 140.

In an example, computing device 160 may include a patch classifier 162 capable of classifying the superimposed image patches to identify a subset of the superimposed image patches overlapping with one or more barcodes that may be associated with received image 140. A preliminary classification may be performed to identify the superimposed image patches that do not contain at least a part of a barcode. Various gradient boosting techniques may be used for the preliminary classification. The remainder of image patches (e.g., the patches with likelihood of containing at least some parts of barcodes) may be classified using a machine learning model to produce a final classification of patches (e.g., the subset of superimposed image patches) overlapping with barcodes in the received image 140.

In an example, computing device 170 may include a patch merging engine 172 capable of merging two or more of the classified subset of superimposed image patches together to form one or more combined image patches. Multiple combined image patches may be produced as a result of merging different sets of image patches. In addition, the patch merging engine 172, or another component within system 100, may refine the combined image patches to identify boundaries of the combined image patches.

In one example, computing device 180 may include a connected component engine 182 capable of generating one or more individual connected components using the one or more combined image patches. Additionally, a crop may be performed along the boundaries of the individual connected component. Optionally, other classifications (e.g., using machine learning algorithms, gradient boosting algorithms, etc.) can be performed by the connected component engine 182, or another component of system 100, to determine whether the area of the connected component corresponds to a barcode. One or more developed (generated) individual connected components may be identified as one or more detected barcodes on the received image.

The repository 120 may be a persistent storage that is capable of storing image 140, objects 141, 142, 143, as well as various data structures used by various components of system 100. Repository 120 may be hosted by one or more storage devices, such as main memory, magnetic or optical storage based disks, tapes or hard drives, NAS, SAN, and so forth. Although depicted as separate from the computing devices 150, 160, 170, and 180, in an implementation, the repository 120 may be part of any of the computing device 150, 160, 170, and 180. In some implementations, repository 120 may be a network-attached file server, while in other embodiments content repository 120 may be some other type of persistent storage such as an object-oriented database, a relational database, and so forth, that may be hosted by a server machine or one or more different machines coupled to the via the network 130.

It should be noted that in some other implementations, the functions of computing devices 150, 160, 170, and 180 may be provided by a fewer number of machines. For example, in some implementations computing devices 150 and 160 may be integrated into a single computing device, while in some other implementations computing devices 150, 160, and 170 may be integrated into a single computing device. In addition, in some implementations one or more of computing devices 150, 160, 170, and 180 may be integrated into a comprehensive image recognition platform.

In general, functions described in one implementation as being performed by the comprehensive image recognition platform, computing device 150, computing device 160, computing device 170, and/or computing device 180 can also be performed on client machines existing in other implementations, if appropriate. In addition, the functionality attributed to a particular component can be performed by different or multiple components operating together. The comprehensive image recognition platform, computing device 150, computing device 160, computing device 170, and/or computing device 180 can also be accessed as a service provided to other systems or devices through appropriate application programming interfaces.

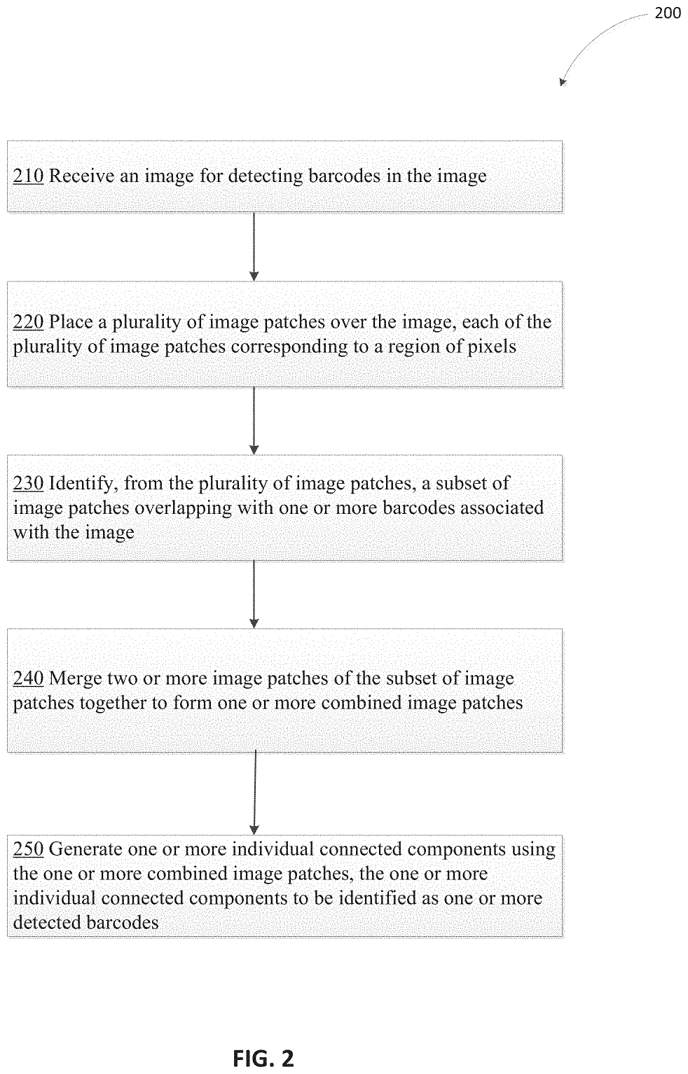

FIG. 2 depicts a flow diagram of one illustrative example of a method 200 for detecting barcodes on an image, in accordance with one or more aspects of the present disclosure. Method 200 and/or each of its individual functions, routines, subroutines, or operations may be performed by one or more processors of the computer system (e.g., example computer system 1100 of FIG. 11) executing the method. In certain implementations, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processing threads implementing method 200 may be executed asynchronously with respect to each other. Therefore, while FIG. 2 and the associated description lists the operations of method 200 in certain order, various implementations of the method may perform at least some of the described operations in parallel and/or in arbitrary selected orders. In one implementation, the method 200 may be performed by one or more of the various components of FIG. 1, such as superimposition engine 152, patch classifier 162, patch merging engine 172, connected component engine 182, etc.

At block 210, the computer system implementing the method may receive an image for detecting barcodes in the image. The image may be used as an input image that is to be analyzed for presence of one or more barcodes therein. For example, the received image may be comparable to the image 140 of FIG. 1. The image may be obtained using various manners, such as, from a mobile phone, a scanner, via a network, etc. The image may include multiple objects within the image. Some of the objects within the image may include one or more types of barcodes. In some example, the image may not contain any barcodes. In some embodiments, the image may additionally be preprocessed using a suitable pre-processing method, such as, local contrast preprocessing, or grayscaling (e.g., processing being provided on grayscale image), or a combination thereof.

At block 220, the computer system may place (e.g., superimpose) a plurality of image patches (also referred herein as “patches”) over the image. Each of the plurality of image patches may correspond to a region of pixels. An image patch may include a container containing a portion of an image. Generally, but not always, the portion of the image may be a rectangular or a square portion. The image patches may cover the entirety of the received image. In an example, an image may exist with the dimensions of 100 pixels (“px”) by 100 pixels (also referred to as “100×100 px”). The image can be divided into containers having smaller portions of the image. The image can be divided into 100 smaller portions of the image. Each portion may have a region with a dimension of 10×10 px, or a total of 100 px per portion. Each portion may be known as an image patch. In an example, a grid may be used to divide an image, where each cell of the grid may represent an image patch. In the example, the computer system may overlay (e.g., superimpose) the grid containing the image patches on the received image. In an example, a simple image may be selected to be used for diving into image patches. For example, the image may contain pixels of only one color.

The image patches may be associated with a patch step. A patch step may correspond to a specified dimension for each of the plurality of image patches. For example, a patch step can be a dimension along the width and height of the patch. Thus, if the image patch has a dimension of, for example, 48×48 px, then a patch step for the image patch is considered to be 48 px. The patch step selected for the image patch may be selected empirically, or from observations or experiments. For example, a patch step may be selected considering the size of a conventional, commonly used barcode. For example, a 48 px patch step may be selected considering the size of a conventional barcode being 60×60 px. The patch step (e.g., the patch size) may be selected such that only a part of the expected barcode fits inside the patch rather than the entire barcode. That is, the patch may contain at least one part of the barcode, rather than the entire barcode.

At block 230, the computer system may identify, from the plurality of image patches, a subset of image patches overlapping with one or more barcodes associated with the image. Identifying the subset of image patches may involve classification of the image patches using various techniques. In an embodiment, the image patches may be classified in stages. For example, a preliminary classification may be performed to identify and exclude image patches that do not contain at least a part of a barcode. For example, the preliminary classification may identify image patches that overlap only with white areas of the received image. Thus, identifying the subset of image patches overlapping with the one or more barcodes may include, at a first (e.g., preliminary) stage, identifying a first set of image patches from the plurality of image patches having at least some likelihood of overlapping with the one or more barcodes. The first stage may also include identifying a second set of image patches from the plurality of image patches having no likelihood of overlapping with the one or more barcodes. The goal in this stage may be to exclude the maximum number of image patches that do not contain at least a part of the barcode. Doing so is helpful for the next stage of classification to be more efficient and accurate.

In some implementations, gradient boosting techniques may be used in the preliminary stage of classification to classify the image patches. Gradient boosting methods may produce a prediction model in the form of an ensemble (e.g., multiple learning algorithms) of weak prediction models, generally using decision trees. Gradient boosting methods may use a combination of features. For example, gradient boosting techniques used in the preliminary stage may include techniques based on one or more of local binary patterns, simple rasterized features of grayscale image, histogram features, skewness, kurtosis, etc.

After the results of the preliminary classification are obtained, the resulting set of image patches may be further classified at a next stage. The image patches of the first set (e.g., the patches with likelihood of containing at least some parts of barcodes) may be further classified using a machine learning model to produce a second stage of classification of patches overlapping with barcodes. Thus, identifying the subset of image patches overlapping with the one or more barcodes may include, at a second stage, identifying the subset of image patches overlapping with the one or more barcodes by classifying the first set of image patches using a machine learning model. The machine learning model may have been particularly trained to detect images containing barcodes.

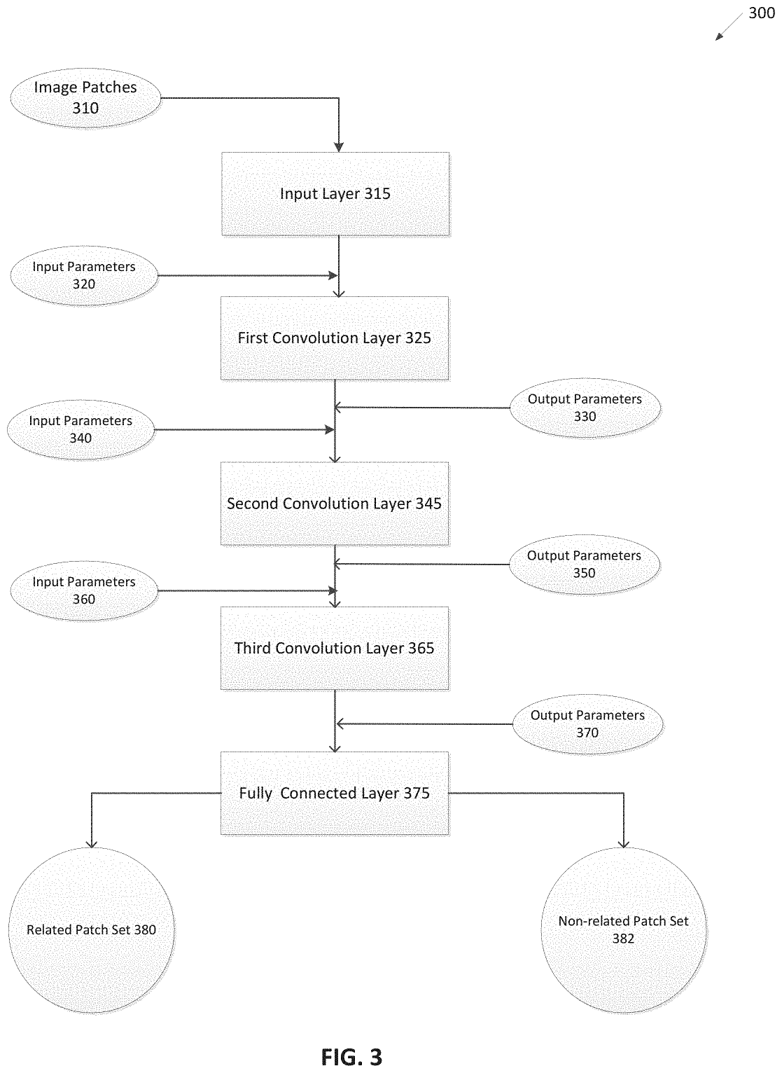

For example, FIG. 3 illustrates a machine learning scheme (e.g., model) 300 to be used for classification of the superimposed image patches. The machine learning schemes may include, e.g., a single level of linear or non-linear operations (e.g., a support vector machine [SVM]) or may be a deep network, i.e., a machine learning model that is composed of multiple levels of linear or non-linear operations. Examples of deep networks are neural networks including convolutional neural networks, recurrent neural networks with one or more hidden layers, fully connected neural networks, etc. Initially, the machine learning model may be trained using training data to be able to recognize contents of various images. Once the machine learning model is trained, the machine learning model can be used for analysis of new images.

For example, during the training of the machine learning model, a set of training images containing barcodes may be provided as input and the barcodes may be identified as output. The model may learn from the training images with barcodes and be able to identify images that have barcodes in the images. If the training requires larger set of training data for effective learning, the training images may be augmented (e.g., increased in number). The augmentation may be performed using various techniques, such as, by rotation of the barcodes on the training set of images, etc.

FIG. 3 shows an example of a machine learning model 300 using a convolutional neural network (“CNN”). A convolutional neural network may consist of layers of computational units to hierarchically process visual data, and may feed forward the results of one layer to another layer, extracting a certain feature from input images. Each of the layers may be referred to as a convolutional layer or convolution layer. The CNN may include iterative filtering of one or more images using the layers, passing the images from one layer to the next layer within the CNN. The filtered images may be fed to each next layer. Each layer or set of layers may be designed to perform a particular type of function (e.g., a particular function for filtering). An image received by the CNN as an input signal may be processed hierarchically, beginning with the first (e.g., input) layer, by each of the layers. CNN may feed forward the output of one layer as an input to the next layer and produce an overall output signal at the last layer.

As shown in FIG. 3, CNN 300 may include multiple computational units arranged as convolutional layers. CNN 300 may include an input layer 315, a first convolutional layer 325, a second convolutional layer 345, a third convolutional layer 365, and a fully connected layer 375. Each layer of computational units may accept an input and produce an output. In one implementation, input layer 315 may receive as an input image patches 310. In an example, image patches 310 may include the superimposed image patches remaining after one set of patches are excluded during the preliminary classification. For example, image patches 310 may include the first set of image patches from the plurality of image patches having at least some likelihood of overlapping with the one or more barcodes, as discussed with reference to FIG. 2. The image patches 310 may include pixels representing parts of one or more barcodes which overlap with the image patches, as the image patches were superimposed on the received image potentially containing barcodes. An input layer may be used to pass on input values to the next layer of the CNN. In that regard, the input layer 315 may receive the image patches in a particular format and pass on the same values as an output of the input layer to further layers. For example, the computational unit of input layer 315 may accept as an input one or more customizable parameters, such as, number of filters, number of channels, customizable bias matrix, etc. The input layer may produce as output the same parameters and pass them on as input parameters to the next layer.

As depicted in FIG. 3, the next layer may be the first convolution layer 325. The first convolution layer 325 may accept input parameters 320 (e.g., output of the input layer 315) as input for the first convolution layer 325. The first convolution layer 325 may be designed to perform a particular computation using the input parameters 320. For example, first convolution layer 325 may include a computational unit that may be referred to as “ConvNdBackward” layer, with a function that uses a forward call and provides default backwards computation. The computational unit may include various components, such as, matrices and other variables used for the computations in combination with the input parameters 320. The components may include batch normalization matrix, batch normalization bias matrix, a layer for batch normalization backwards function computation, activation of a backwards function layer (e.g., an example “LeakyReluBackward” layer), max pooling backward layer (e.g., backpropagation that stores the index that took the max), etc. The backpropagation gradient may be the input gradient at that index. As a result of the computation performed by first convolution layer 325, output parameters 330 may be produced.

The output parameters 330 may be fed to the next layer, second convolution layer 345 as input parameters 340. The second convolution layer 345 may produce output parameters 350, which may be fed to the third convolution layer 365 as input parameters 360. The third convolution layer 365 may produce output parameters 370, which may be fed to the fully connected layer 375. Each of the second convolution layer 345 and third convolution layer 365 may comprise an architecture similar to that of the architecture described for the first convolution layer 325, including accepting the types of input parameters, having the components including the matrices and computational layers or units, and producing the types of output parameters. The fully connected layer 375 may take the output parameters 370 and identify two sets of image patches. The first set may be related patch set 380 which may include patches classified as related to barcodes. The second set may be non-related patch set 382 which may include patches classified as not related to barcodes. The first set, the related patch set 380, may be identified as the subset of image patches overlapping with the one or more barcodes, as described with reference to block 230 of FIG. 2. It should be noted that in some embodiments, the classification at block 230 may include only one stage of classification rather than the two stages (e.g., gradient boosting and CNN) as described above. In an example, all superimposed image patches may be fed to the CNN 300 and classified in related and non-related patch sets using CNN 300.

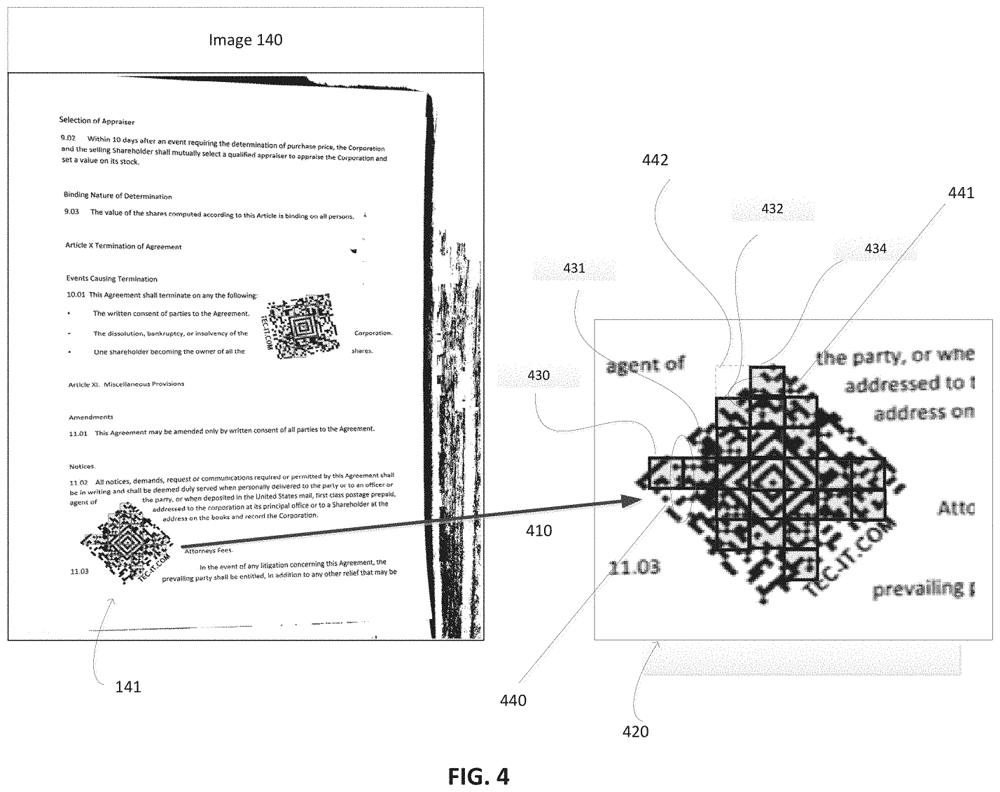

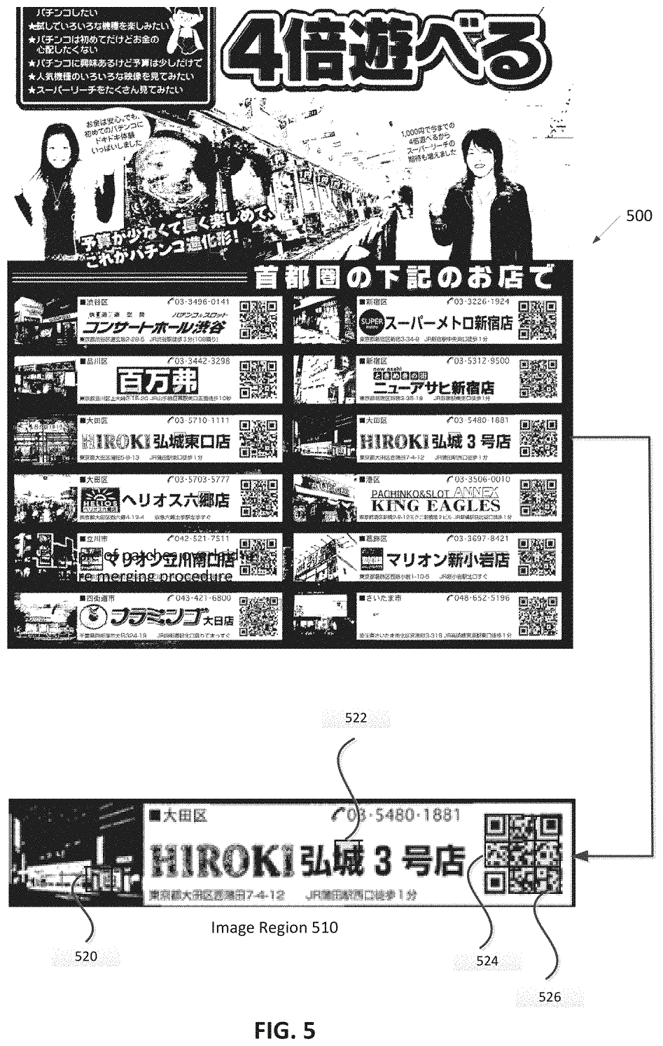

Referring back to FIG. 2, at block 240, the computer system may merge two or more image patches of the subset of image patches together to form one or more combined image patches. For example, FIG. 4 illustrates classified image patches that have been identified as containing one or more parts of the barcode with the image patches overlapping with the barcodes prior to merging image patches. In an example, after received image 140 of FIG. 1 containing object 141 have been classified, a subset of image patches overlapping with object 141 has been identified as image patches overlapping with one or more barcodes associated with image 140. Arrow 410 points to an enlarged version of object 141 of image 140 within the area 420. An example of an image patch may include a square area 430 depicted within area 420 of image 140. Area 420 depicts multiple image patches (e.g., image patches 430, 431, 432, 434, etc.) overlapping with object 141 and the image patches have been classified as belonging to the subset of image patches overlapping with one or more barcodes or parts of barcodes. FIG. 4 shows the image patches prior to the patches being merged. Similarly, FIG. 5 shows a an image 500 which contains regions comprising barcodes. Image patches overlaid over the image 500 have been classified to identify a subset of image patches in each image region that overlap with one or more barcodes associated with the image. Image region 510 is an enlarged version of one of the image regions of the image 500. Image region 510 depicts a subset of image patches (e.g. patches 520, 522, 524, 526, etc.) overlapping with various objects in image region 510 and have been classified as belonging to the subset of image patches overlapping with one or more potential barcodes or parts of barcodes.

The merging of the two or more image patches together may include merging the image patches using a neighbor principle. The merging may result into connected areas of the image patches being built. Connected areas may be built by connecting areas of the two or more image patches of the subset of image patches where two points of the two or more image patches are associated with each other via a sequence of neighbors. Neighbor principle is related to natural topology and geometry of a discrete digital image. Two patches may be considered as neighbor patches if the two patches share geometrically common borders.

Applying neighbor principle on the image patches, the computer system may merge two or more image patches, including two or more of patches 430, 431, 432, and 434 of image 140 and two or more of patches 520, 522, 524, and 524 of image region 510, together to form one or more combined image patches. In an implementation, the computer system may consider a first image patch and a second image patch for merging. If the first and the second image patches have at least one common border, the first and second image patches are merged together. All image patches in the subset are considered following the same method and merged together when at least one common border is identified. For example, image patch 430 and image patch 431 have at least one common border 440. Thus image patch 430 and image patch 431 are merged together to form a combined image patch.

In one implementation, the computer system may consider two image patches for merging and identify if there exists at least one common neighbor image patch between the two patches. If a common neighbor is identified, one of the image patches is merged with the common neighbor. It should be noted that the common neighbor image patch may not be an image patch that was included within the subset of image patches identified as overlapping with one or more barcodes. After each image patch is considered individually and merged, the process is performed iteratively to merge the newly formed combined image patches. For example, image patch 432 and 434 do not individually have common border between the image patches. However, the patches 432 and 434 may be merged through intermediate patches. Patch 432 may be merged with the patch to the right of patch 432 as a result of having a common border. Once the patches are merged and form a combined patch, patch 432 and the patch to the right of it, as a combined patch, shares a common border 441. As a result, the combined patch, including the patch 432 and the patch to the right of it, may be merged with patch 434 and its neighbor patch 442 having the common border 441. Image patch 442 is identified by dotted lines because the patch was not included in the subset of patches identified as overlapping with barcodes.

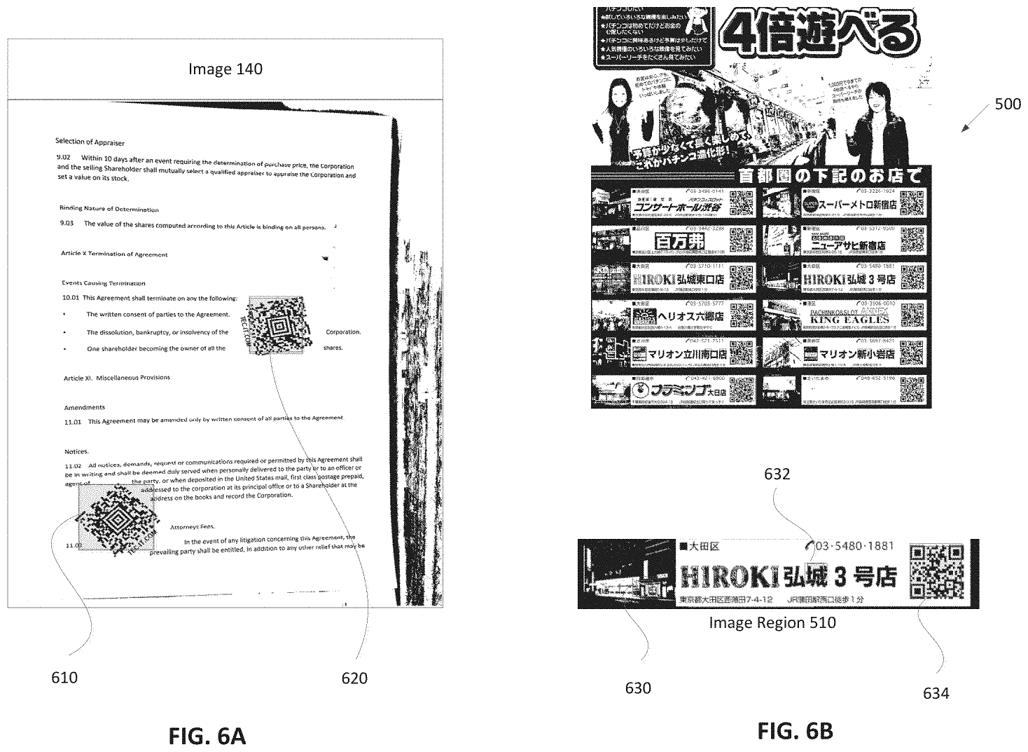

The process of considering the intermediate image patches and merging them may continue until no pair of image patches remains to be merged. At the end of the process of merging the image patches together, an overall combined image patch is obtained for area 420 of image 140. FIG. 6A illustrates the overall combined image patch 610 after the merging of two or more image patches of the subset of image patches. FIG. 6A also depicts a second combined image patch 620 that was obtained as a result of classification of the image patches overlaid on image 140 and merging the appropriate image patches using the neighbor principle. Following the process, the computer system is able to identify all areas of the image 140 potentially containing one or more barcodes. Similarly, FIG. 6B shows the resulting combined image patches after merging image patches for image 500. For example, the merging for image region 510 produced three combined image patches 630, 632, and 634.

In one embodiment, after merging, the computer system may also refine boundaries of the areas containing potential barcodes. Boundaries of the combined image patches containing the potential barcodes may intersect (e.g., cross over) the actual barcodes such that some parts of the barcodes are outside of the boundaries of the combined image patches. As a result, boundaries may need to be refined to capture the barcodes in full without cutting the barcodes off. Refining the boundaries may include selecting an area comprising the combined image patch such that the area is one patch step larger than the combined image patch in each direction of the combined image patch. Once the area is selected, the selected area may be binarized. A histogram of stroke widths associated with the area may be built. A maximum width value may be selected from the histogram, the maximum value being from the largest peak on the histogram. A binary morphology may be performed on the binarized area using the maximum width value to identify refined boundaries of the combined image.

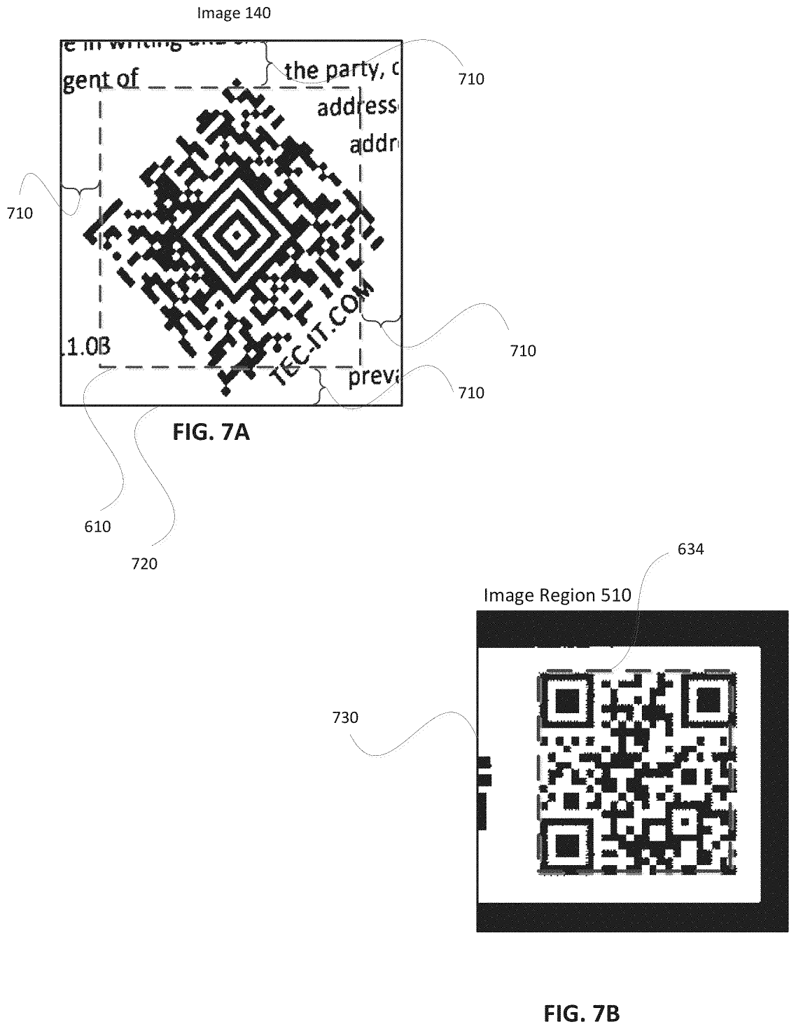

For example, as shown in FIGS. 7A and 7B, the boundaries of combined image patch 610 of image 140 and combined image patch 634 of image region 510 may be refined. FIG. 7A depicts that the area indicated by dotted line containing the four boundaries of the combined image patch 610 is expanded in all four directions of the area surrounding the combined image patch 610. The expansion results into a new area with refined boundaries indicated by the solid lines 720 that include the previous boundaries of combined image patch 610. The difference 710 between the previous boundaries of image patch 610 and the new boundaries 720 may be one patch step. As described with regards to block 220 of FIG. 2, a patch step may correspond to a specified dimension for each of the plurality of image patches. A patch step for image patches (e.g., image patch 430 depicted in FIG. 4) overlaid on image 140 may have been selected as 48 px (or another suitable value). Thus, in an example when the patch step is 48 px, the expanded area with boundaries 720 may be 48 px larger than the combined image patch 610 in each of the four directions along the previous boundaries of patch 610. Similarly, the area surrounding combined image patch 634 is expanded one patch step to all directions to refined boundaries in FIG. 7B.

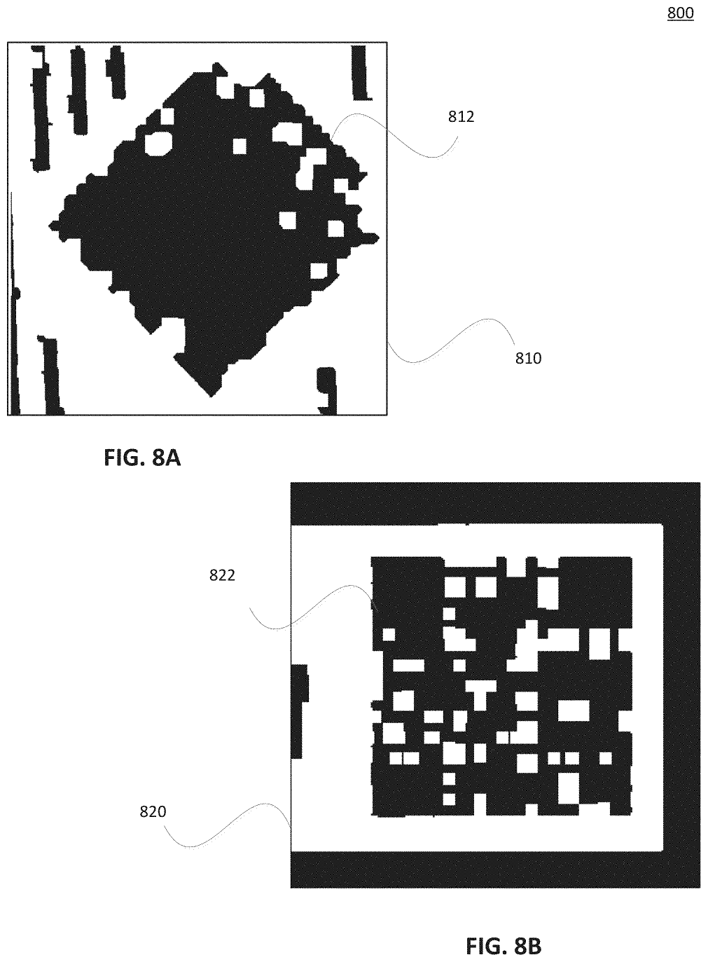

After the expansion of the boundaries, the area captured within the new boundaries may be binarized and a histogram of stroke width may be built using the binarized image within the captured area. For example, FIGS. 8A and 8B each illustrates area 810 and area 820 corresponding to the areas captured within new boundaries 720 of FIG. 7A and boundaries 730 of FIG. 7B, respectively. The image 812 within area 810 and the image 822 within area 820 are binarized images obtained from images that were within boundaries 720 and 730, respectively. A histogram of stroke width is built using each binarized image within each area. Stroke width of a pixel may be decided by minimum value of the run-length along four directions (horizontal, vertical, and two diagonals). The run-length may be the number of pixels on the pixel's four edge directions. The pixel stroke width values may be statistically represented on a histogram of stroke width. From the largest peak on the histogram, the maximum value may be selected corresponding to the one barcode point. After the maximum value is selected, a binary morphology using a closing operation may be performed with the width of the selected maximum value. Binary morphology is a set of fundamental operations on binary images. Particularly, a closing operation is used for noise removal from images, removing small holes from an image. After the morphology is performed, some white holes from the image within area 810 (or 820) may be filled in. Particularly, because the operation is performed with the width of the selected maximum value, the regions (e.g., holes) that are filled are those whose width corresponds to the width of the structural morphological element (e.g., the maximum width parameter). The height of the structural element can be calculated from the width and aspect ratio of the barcode within the area 810 or 820 (e.g., taking into account the height of the barcode element).

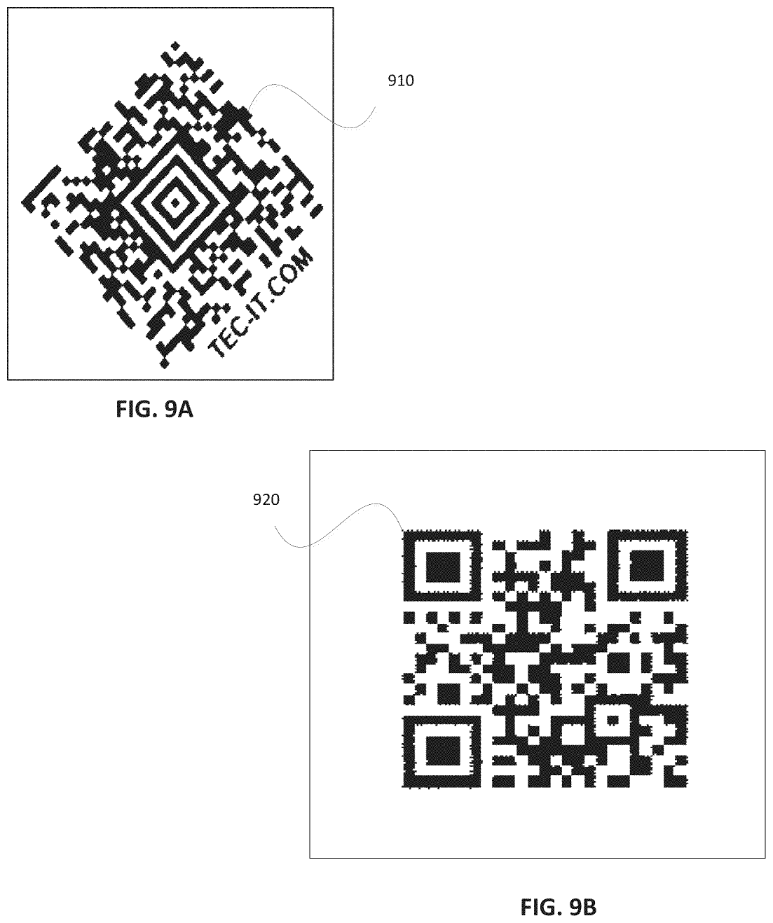

Referring back to FIG. 2, at block 250, the computer system may generate one or more individual connected components using the one or more combined image patches. For example, FIGS. 9A and 9B each illustrates an individual connected component 910 and 920, respectively. The individual connected component 910 (or 920) may be generated using the combined image patch obtained from merging the initial image patches superimposed on an image. The individual connected component may be derived from a binarized image (e.g., image 812 of FIG. 8A, image 822 of FIG. 8B, etc.) obtained using the combined image patch. Connected component analysis may be used to detect connected regions in binary digital images. Connected component analysis (also known as “connected component labeling”) scans an image and groups the pixels of the image into components based on pixel connectivity. Pixel connectivity may be determined based on pixel intensity values. The connectivity may be 4-connectivity or 8-connectivity. In an example, if neighbors of a pixel share the same intensity values of the pixels, then the pixel and neighbors sharing the intensity values are grouped in a connectivity component.

In an implementation, a minimal connectivity component may be identified which is located in the center of the binarized image 812 of FIG. 8A. The size of the minimal connectivity component may be determined based on the total area of the barcode image. If the minimal connectivity component is too large, the individual connected component 910 can capture excessive background areas beyond the actual barcode boundaries. If the minimal connectivity component is too small, parts of the barcode can be lost from the individual connected component 910. Thus, the size of the minimal connectivity component may be specified such that the size is relative to the size of the barcode area. In one example, the size of the minimal connectivity component may be specified as being ⅛ of the barcode area 810 or 820. Once the minimal connectivity component is identified, other connectivity components around the minimal connectivity component may be merged with the minimal connectivity component. Once all connectivity components within the binarized image are merged, a single (e.g, individual) connected component 910 may be derived, as shown in FIG. 9A.

The one or more individual connected components identified within each received image (e.g., image 140, image region 510) may be identified as one or more detected barcodes. A crop may be performed along the boundaries of the one or more of the individual connected components to identify the boundary of the detected barcode. In one implementation, an optional post classification of the individual connected component may be performed to confirm that the detected area indeed corresponds to a barcode. In some example, the post classification may be performed using a machine learning model, such as a CNN. In some example, the post classification may be performed using gradient boosting algorithm based on one or more of features from rasterized features, histogram stroke width features, Haar algorithm, scale invariant feature transform (SIFT), histogram of oriented gradients (HOG), binary robust invariant scalable keypoints (BRISK), or speeded up robust features (SURF).

The detected barcode may be provided for recognition. FIG. 10 illustrates examples of types of barcodes that can be detected using the detection mechanism described herein. The barcodes may include, but not be limited to, a QR code 1010, a DataMatrix 1020 and 1050, a ScanLife EZcode 1030, a Microsoft Tag 1040, an Aztec code 1060, a MaxiCode 1070, a Codablock 1080.

In some examples, the above described mechanism to detect the barcodes may be performed multiple times (e.g., 3 times) with varying resolution each time. The resolution can vary by a factor of 2 each time. For example, the resolution can be 1:1, then 1:2, and then 1:4, beginning with the operation to superimpose image patches on the image with different resolutions. In this manner, it may be possible to detect all barcodes located on the same image, even though the sizes of the barcodes may significantly vary within the image.

FIG. 11 depicts a component diagram of an example computer system which may execute instructions causing the computer system to perform any one or more of the methods discussed herein, may be executed. The computer system 1100 may be connected to other computer system in a LAN, an intranet, an extranet, or the Internet. The computer system 1100 may operate in the capacity of a server or a client computer system in client-server network environment, or as a peer computer system in a peer-to-peer (or distributed) network environment. The computer system 1100 may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 1100 includes a processor 1102, a main memory 1104 (e.g., read-only memory (ROM) or dynamic random access memory (DRAM)), and a data storage device 1118, which communicate with each other via a bus 1130.

Processor 1102 may be represented by one or more general-purpose processing devices such as a microprocessor, central processing unit, or the like. More particularly, processor 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 1102 may also be one or more special-purpose processing devices such as an application specific integrated circuit (ASIC), a field programmable gate array (FPGA), a digital signal processor (DSP), network processor, or the like. Processor 1102 is configured to execute instructions 1126 for performing the operations and functions of method 200 for detecting barcodes on images, as described herein above.

Computer system 1100 may further include a network interface device 1122, a video display unit 1110, a character input device 1112 (e.g., a keyboard), and a touch screen input device 1114.

Data storage device 1118 may include a computer-readable storage medium 1124 on which is stored one or more sets of instructions 1126 embodying any one or more of the methods or functions described herein. Instructions 1126 may also reside, completely or at least partially, within main memory 1104 and/or within processor 1102 during execution thereof by computer system 1100, main memory 1104 and processor 1102 also constituting computer-readable storage media. Instructions 1126 may further be transmitted or received over network 1116 via network interface device 1122.

In certain implementations, instructions 1126 may include instructions of method 200 for detecting barcodes on images, as described herein above. While computer-readable storage medium 1124 is shown in the example of FIG. 11 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying,” “generating” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, by a processing device, an image for detecting one or more barcodes on the image;
placing a plurality of image patches over the image, each of the plurality of image patches corresponding to a region of pixels;
identifying, from the plurality of image patches, a subset of image patches overlapping with the one or more barcodes associated with the image;
merging two or more image patches of the subset of image patches together to form one or more combined image patches; and
generating one or more individual connected components using the one or more combined image patches, the one or more individual connected components to be identified as one or more detected barcodes.

2. The method of claim 1, further comprising:
preprocessing the image prior to placing the plurality of image patches over the image using one or more of:
local contrast preprocessing, or
grayscaling.

3. The method of claim 1, wherein the plurality of image patches is associated with a patch step, wherein the patch step corresponds to a specified dimension for each of the plurality of image patches.

4. The method of claim 1, wherein identifying the subset of image patches overlapping with the one or more barcodes comprises:
identifying a first set of image patches from the plurality of image patches having at least some likelihood of overlapping with the one or more barcodes; and
identifying the subset of image patches overlapping with the one or more barcodes by classifying the first set of image patches using a machine learning model.

5. The method of claim 4, wherein identifying the first set of image patches comprises:
classifying the plurality of image patches using gradient boosting techniques based on one or more of: local binary patterns, simple rasterized features of grayscale image, histogram features, skewness, or kurtosis.

6. The method of claim 4, wherein the machine learning model comprises a convolutional neural network that has been trained using images containing barcodes.

7. The method of claim 1, wherein merging the two or more image patches of the subset of image patches together comprises:
merging the two or more image patches of the subset of image patches using neighbor principle.

8. The method of claim 7, wherein merging the two or more image patches of the subset of image patches together comprises:
connecting areas of the two or more image patches wherein the two or more image patches have at least one common border.

9. The method of claim 3, further comprising refining boundaries of a combined image patch of the one or more combined image patches by:
selecting an area comprising the combined image patch, wherein the area is one patch step larger than the combined image patch in each direction of the combined image patch;
performing binarization of image within the area;
building a histogram of stroke widths associated with the area;
selecting a maximum width value from the histogram; and
performing binary morphology on the binarized image within the area using the maximum width value to identify refined boundaries of the combined image.

10. The method of claim 1, further comprising:
performing a crop along the boundaries of each of the one or more individual connected components.

11. The method of claim 1, further comprising:
classifying a portion of the image containing the one or more connected components to determine whether the portion corresponds to the one or more barcodes using one or more of:
a machine learning model, or gradient boosting algorithm based on one or more of: rasterized features, histogram stroke width features, Haar algorithm, scale invariant feature transform (SIFT), histogram of oriented gradients (HOG), binary robust invariant scalable keypoints (BRISK), or speeded up robust features (SURF).

12. A system comprising:
a memory; and
a processor, coupled to the memory, the processor to:
receive an image for detecting one or more barcodes on the image;
place a plurality of image patches over the image, each of the plurality of image patches corresponding to a region of pixels;
identify, from the plurality of image patches, a subset of image patches overlapping with the one or more barcodes associated with the image;
merge two or more image patches of the subset of image patches together to form one or more combined image patches; and
generate one or more individual connected components using the one or more combined image patches, the one or more individual connected components to be identified as one or more detected barcodes.

13. The system of claim 12, wherein the plurality of image patches is associated with a patch step, wherein the patch step corresponds to a specified dimension for each of the plurality of image patches.

14. The system of claim 12, wherein to identify the subset of image patches overlapping with the one or more barcodes, the processor is to:
identify a first set of image patches from the plurality of image patches having at least some likelihood of overlapping with the one or more barcodes; and
identify the subset of image patches overlapping with the one or more barcodes by classifying the first set of image patches using a machine learning model.

15. The system of claim 12, wherein to merge the two or more image patches of the subset of image patches together, the process is to:
merge the two or more image patches of the subset of image patches using neighbor principle.

16. The system of claim 15, wherein to merge the two or more image patches of the subset of image patches together, the process is to:
connect areas of the two or more image patches wherein the two or more image patches have at least one common border.

17. The system of claim 13, wherein the processor is further to:
select an area comprising the combined image patch, wherein the area is one patch step larger than the combined image patch in each direction of the combined image patch;
perform binarization of image within the area;
build a histogram of stroke widths associated with the area;
select a maximum width value from the histogram; and
perform binary morphology on the binarized image within the area using the maximum width value to identify refined boundaries of the combined image.

18. A computer-readable non-transitory storage medium comprising executable instructions that, when executed by a processing device, cause the processing device to:
receive an image for detecting one or more barcodes on the image;
place a plurality of image patches over the image, each of the plurality of image patches corresponding to a region of pixels;
identify, from the plurality of image patches, a subset of image patches overlapping with the one or more barcodes associated with the image;
merge two or more image patches of the subset of image patches together to form one or more combined image patches; and
generate one or more individual connected components using the one or more combined image patches, the one or more individual connected components to be identified as one or more detected barcodes.

19. The computer-readable non-transitory storage medium of claim 18, wherein the plurality of image patches is associated with a patch step, wherein the patch step corresponds to a specified dimension for each of the plurality of image patches.

20. The computer-readable non-transitory storage medium of claim 18, wherein to identify the subset of image patches overlapping with the one or more barcodes, the processing device is to:
identify a first set of image patches from the plurality of image patches having at least some likelihood of overlapping with the one or more barcodes; and
identify the subset of image patches overlapping with the one or more barcodes by classifying the first set of image patches using a machine learning model.
